(19) United States
(12) Patent Application Publication
(10) Pub. No.: US 2018/0316996 A1
(43) Pub. Date: Nov. 1, 2018

(54) Powered Speaker Installation Box with Controls

(71) Applicant: Joshua David Johnson, Kalispell, MT (US)

(72) Inventor: Joshua David Johnson, Kalispell, MT (US)

(21) Appl. No.: 15/635,036

(22) Filed: Jun. 27, 2017

Related U.S. Application Data
(60) Provisional application No. 62/490,584, filed on Apr. 26, 2017.

(51) Int. Cl. H04R 1/02; G06F 3/16

(52) U.S. Cl. CPC H04R 1/026; G06F 3/165

(57) ABSTRACT

a powered speaker installation box comprising a housing securable into a wall, with an electronics retention system, a power system, a sound-transparent grate, and a grate securement system. The speaker box may also comprise a speaker circuit board, a speaker set, and a speaker mounting panel.

### CROSS-REFERENCE TO RELATED APPLICATIONS

This application claims the benefit of U.S. Application No. 62/490,584, filed on Apr. 26, 2017, by the present inventor, entitled “Powered Speaker Installation Box with Controls,” which is hereby incorporated by reference in its entirety for all allowable purposes, including the incorporation and preservation of any and all rights to patentable subject matter of the inventor, such as features, elements, processes and process steps, and improvements that may supplement or relate to the subject matter described herein.

### STATEMENT REGARDING FEDERALLY SPONSORED RESEARCH OR DEVELOPMENT

Not Applicable

### BACKGROUND OF THE INVENTION

This invention relates generally to sound system installation equipment, and more specifically to speaker systems installed into the wall or ceiling of a room. Currently, installed speaker systems include hard-wired systems that may be installed within the wall of a room and directly connected to an electron sound system with wiring that is ran through the walls. Additionally, wireless speakers are available that receive a signal from the sound system through various means, including radio waves, which include such technologies as WiFi and Bluetooth® technologies. It would be an improvement to the field of art to provide a powered installation box that includes a housing for wireless speaker equipment, a suitable power source for the speaker, and a removable sound-transparent grate to obscure the electronics within the wall. The installation box permits the use of self-contained powered wireless speakers to be used to give the appearance of a more costly in-wall wired speaker system, with advantages of harmonic distortion or analogue loss from impedance in the wiring.

### SUMMARY OF THE INVENTION

The current development is a powered speaker installation box that enables in-wall installation of remote powered speakers. The powered speaker installation box comprising a housing securable into a wall, with an electronics retention system, a power system, a sound-transparent grate, and a grate securement system. The speaker box may also comprise a speaker circuit board, a speaker set, a speaker mounting panel, and speaker controls.

### BRIEF DESCRIPTION OF THE DRAWINGS

FIG. 1 is a front side photograph of an exemplary embodiment of a powered speaker installation box according to the present disclosure.

FIG. 2 is an oblique photograph of the installation box of FIG. 1.

FIG. 3 is an oblique photograph of the installation box of FIG. 1, with a wireless speaker positioned therein.

FIG. 4 is a front side photograph of the installation box of FIG. 1, with a sound-transparent grate installed.

FIG. 5 is an oblique photograph of an exemplary transformer installation.

FIG. 6 is an oblique photograph of an exemplary wireless speaker suitable for providing internal electronic components for an exemplary powered speaker installation box, according to the present disclosure.

FIG. 7 is an oblique photograph of the wireless speaker housing in FIG. 6, with the electronic components removed.

FIG. 8 is an oblique photograph of the electronic circuit board from the wireless powered speaker of FIG. 6.

FIGS. 9 and 10 are oblique photographs of the electronic circuit board of FIG. 8 installed in an exemplary housing.

FIG. 11 is an oblique rear photograph of the speaker components from the wireless powered speaker of FIG. 6, mounted on an exemplary speaker mounting panel.

FIG. 12 is a front photograph of the speaker components from the wireless powered speaker of FIG. 6, mounted on an exemplary speaker mounting panel.

FIG. 13 is a front photograph of an exemplary sound-transparent speaker grate.

### DESCRIPTION OF THE PREFERRED EMBODIMENT

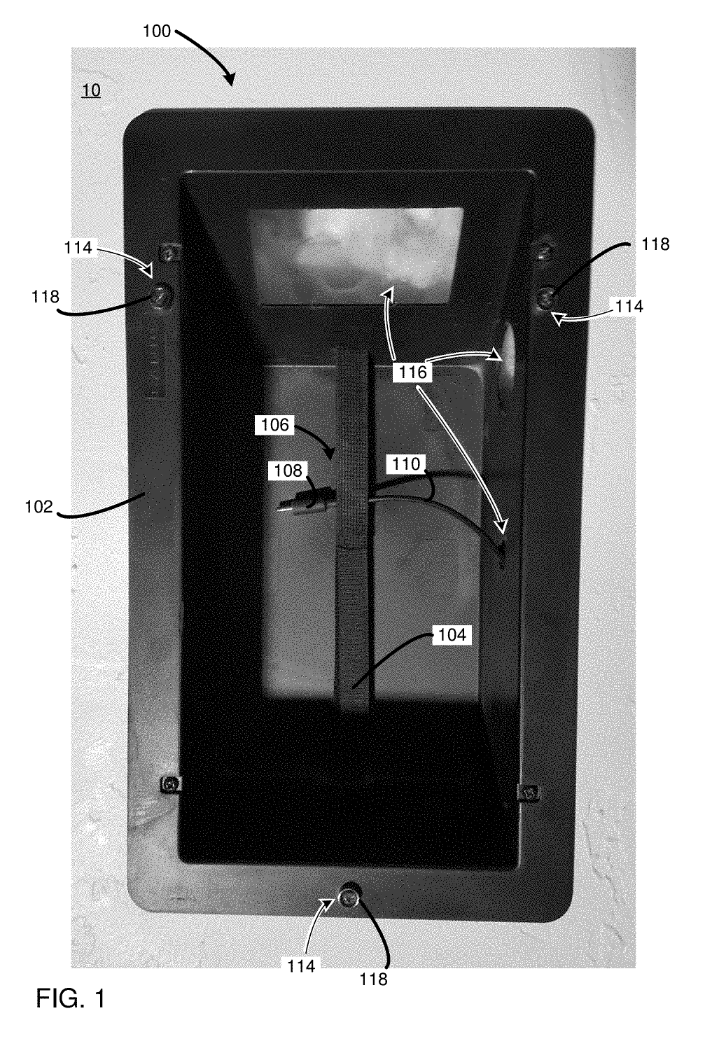

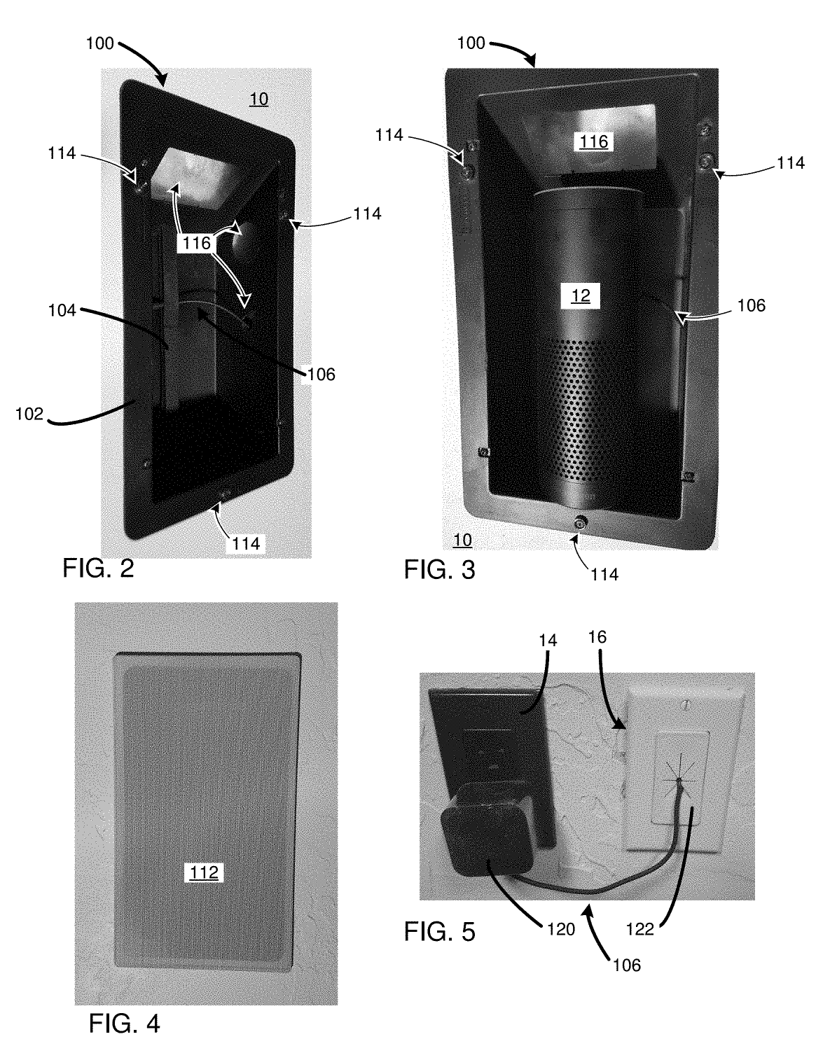

Referring to FIG. 1 through 4, an exemplary embodiment of a powered speaker installation box 100 according to the present disclosure is depicted. An exemplary powered speaker installation box 100 may comprise a housing 102 that is suitable to be secured within a wall 10, an electronics retention system 104, a power system 106, a sound-transparent grate 112, and a grate securement system 114. An exemplary housing 102 may have at least one access orifice 116, through which wiring may be routed between the interior and the exterior of the housing 102. An exemplary power system 106 may comprise a power connector 108, a power cord 110, and a transformer 120. The housing 102 may be configured with a wall securement system, of which suitable designs may be known in the field of art for electrical wiring wall boxes. The wall securement system may be suitable for renovation installation, where an existing wall 10 may be minimally breached to receive a housing 102, or for new construction, where a wall 10 is assembled to include a housing 102. It is envisioned that the power system 106 may include an electrical outlet 14 being positioned in an appropriate access orifice 116, so as to facilitate a ready supply of power to the interior of the housing 102.

In the exemplary embodiment, a housing 102 supports an electronics retention system 104. An electronics retention system 104 may be used to secure various self-contained powered wireless speaker unit 12 within the housing 102. It is also appreciated that a powered speaker installation box 100 may accommodate a stand-alone compact music system, which may include components such as an output speaker, amplifier, music source interface, control interface, and wireless communications module. It is also appreciated that audio signals may be transmitted to the powered wireless speaker unit 12 by a wireless transmission technology. It is also appreciated that audio signals may be transmitted to the powered wireless speaker unit 12 by a wired digital connection, such by Ethernet.

Suitable self-contained wireless speaker unit may include the UE BOOM 2™ wireless speaker made by a division of Logitech International S.A., a variety of Bose Corporation SoundLink™ and SoundTouch™ wireless speakers, and a variety of Sonos, Inc., wireless speakers, such as the Play:1™ and Play:3™ speakers, just to name a few. With a self-contained powered wireless speaker unit 12 so secured, powered speaker installation box 100 may assume varied orientations to be positioned aesthetically within wall 10, ceiling (not shown) or floor surface (not shown).

In the exemplary embodiment, a sound-transparent grate 112 may be installed to hide the powered wireless speaker unit 12 within the powered speaker installation box 100, and provide a desired finished look. The sound-transparent grate 112 is held in position against the housing 102 by the grate securement system 114. The grate securement system 114 may provide varied degrees of removability. An exemplary sound-transparent grate 112 may be screwed or adhered to the housing 102 to attain a more permanent securement. Alternatively, an exemplary sound-transparent grate 112 may be attached to the housing 102 by a more conveniently removable system, such as rare-earth magnets 118, hook-and-loop fasteners (not shown), and prong-and-spring-latch fasteners (not shown).

Referring now to FIG. 5, an exemplary transformer installation configuration is shown. A transformer 120 may be used to provide appropriate power to the power system 106. The power system 106 may comprise its own transformer 120 or the powered wireless speaker unit 12 may use standard 110v AC current, in which case a standard electrical plug (not shown) could be used to connect to the electrical outlet 14. In either instance, a power cord 110 may be routed into wall 10 through a wall access 16, and up the interior of the wall 10 to a powered speaker installation box 100. A power cord 110 would then be routed from within the wall 10 through a suitable access panel 122.

In an alternate exemplary embodiment, an alternate powered speaker installation box 200 may comprise a housing 202 that is suitable to be secured within a wall 10, an electronics protection system 204, a power system 206, electronic components 208, a sound-transparent grate 212, and a grate securement system 214. An exemplary power system 206 may comprise a power cord 210 that may connect to the electronic components 208 within the housing 202, and pass through the housing 202 to connect to a power supply. As with powered speaker installation box 100, the housing 202 may be configured with a wall securement system, of which suitable designs may be known in the field of art for electrical wiring wall boxes.

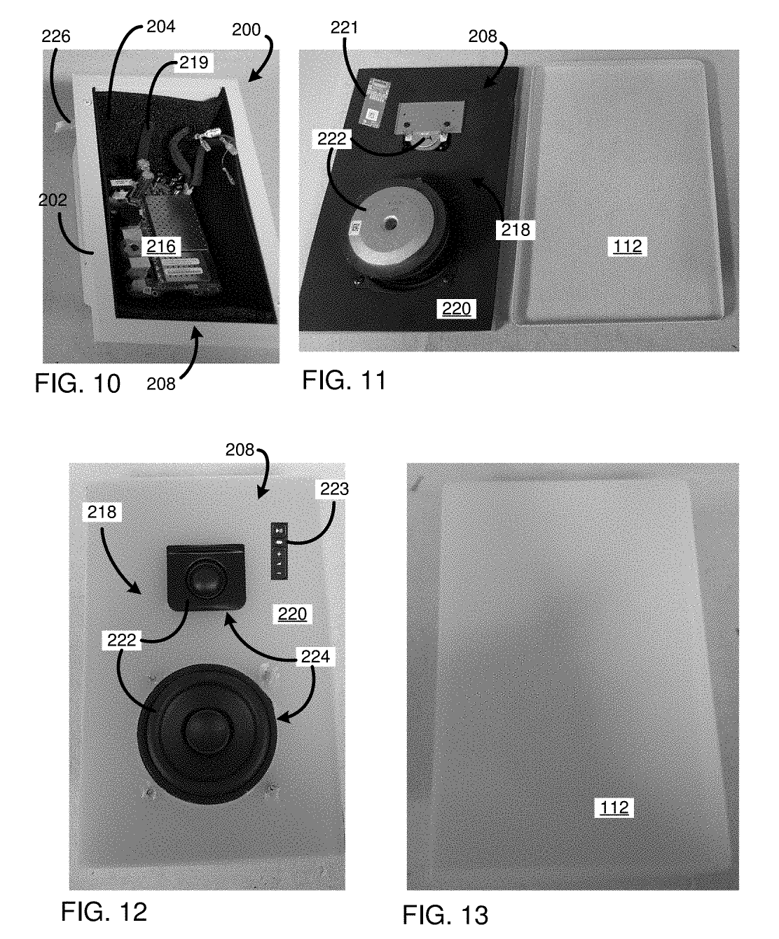

An exemplary wall securement system is shown in FIG. 10 as a wing tab 226 that is rotatable between a stowed position and a deployed position. The exemplary wing tab 226 is shown in the deployed position. In this position, the wing tab 226 may be drawn tight against the inner surface of the wall covering, such as a panel of sheetrock, binding the wall covering between the wing tab 226 and a portion of the housing 202.

In the exemplary embodiment, electronic components 208 may include a speaker circuit board 216, a speaker set 218, a controls ribbon harness 219, a speaker mounting panel 220, a ribbon harness connector 221, and a control set 223. An exemplary electronics protection system 204 may be as simple as a padded material that receives and protects the electronic components 208. It is advisable to ensure the material is non-conductive and heat-resistant.

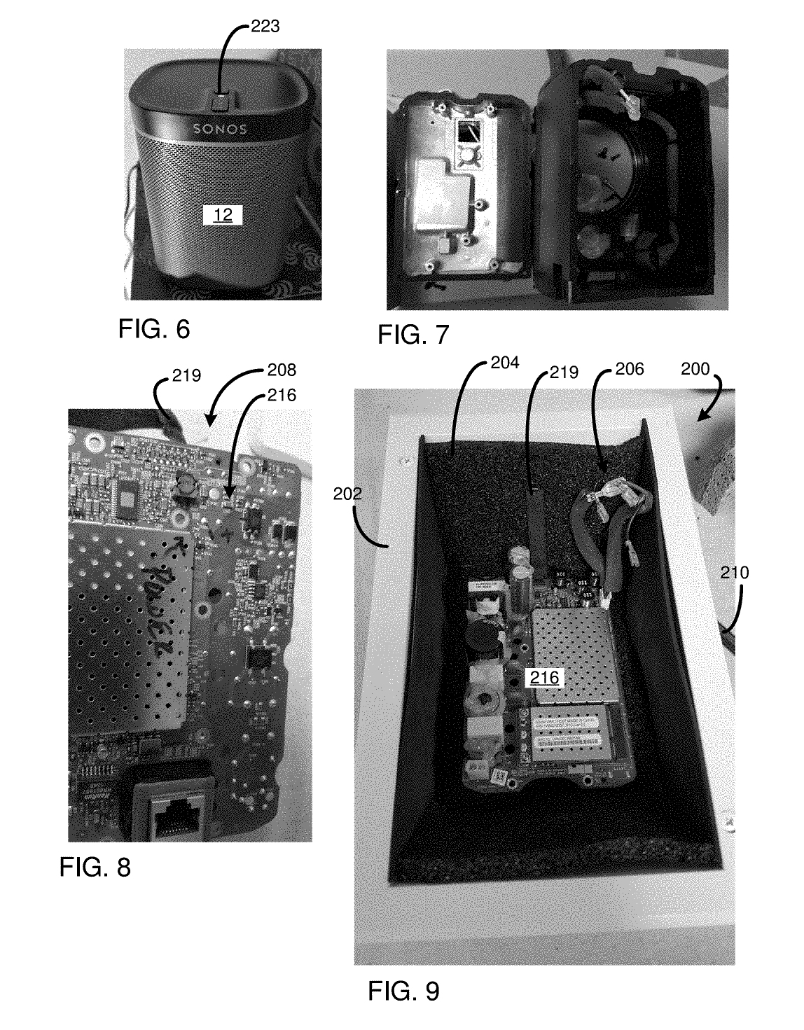

Appropriate exemplary electronic components 208 may be obtained from a self-contained speaker system, such as the Sonos™ speaker shown in FIG. 6. After opening the case, shown in FIG. 7, the circuit board 216 shown in FIG. 8 and the speaker set 218 shown in FIG. 11, may be removed. A circuit board 216 may be connected to a power system 206 and positioned within an electronics protection system 204 of a housing 202. A power cord 210, connected to the electronic components 208 is routed through the housing 202 to reach an external power source.

The speaker set 218 may consist of one or more individual speakers 222, and may include a speaker array or package, such as a matched tweeter, midrange, and woofer. In the exemplary embodiment, each individual speaker 222 may be secured to a speaker mounting panel 220. An exemplary speaker mounting panel comprises appropriate openings 224 at locations where an individual speaker 222 may be mounted. An exemplary speaker mounting panel may be appropriately shaped and sized to fit securely within the housing 202. An individual speaker 218 may be attached to the speaker mounting panel 220 by various acceptable methods. Additionally, a control set 223 may be mounted on the speaker mounting panel 220, to provide operational functionality, such as on, off, change source, and reset. The original control set 223 may be suitable, and may maintain the original functionality. The control set 223 may be connected to the circuit board by a controls ribbon harness 219. The original controls ribbon harness 219 may be suitable.

In the exemplary embodiment, the circuit board 216 is connected to the speaker set 218, and the circuit board 216 is connected to the speaker set 218 are mounted into the housing 202. An exemplary sound-transparent speaker grate 112 may then be attached to the housing 202 may be attached to hide the electronic components 208 within the alternate powered speaker installation box 200 to provide a desired finished look. As with powered speaker installation box 100, a grate securement system (not shown) may be included to appropriately secure the sound-transparent speaker grate 112 to the housing 202.

The examples contained in this specification are merely possible implementations of the current system, and alternatives may still fall within the scope of the allowed claims. The foregoing disclosure and description of the invention is illustrative and explanatory thereof. The present invention should only be limited by the following claims and their legal equivalents, since the provided exemplary embodiments are only examples of how the invention may be employed, and are not exhaustive.

I claim:

1. A speaker installation box, for placement recessed within a wall, comprising:
a housing having a housing interior, a housing exterior and a wall securement system;
the wall securement system capable of securing the housing recessed within the wall;
the housing interior sized to receive a wireless speaker circuit board and a speaker set;
a power connector positionable in the housing interior; and
a power access orifice in the housing supporting the routing of power cord between the housing exterior and the housing interior.

2. The speaker installation box of claim 1, further comprising:
an attachable housing front and front attachment system.

3. The speaker installation box of claim 2, wherein the housing front being a sound-transparent grate;

4. The speaker installation box of claim 3, further comprising:
a speaker control set on the sound-transparent grate.

5. The speaker installation box of claim 4, wherein the speaker control set including operational functionality of one or more of power on, power off, change source, and reset.

6. The speaker installation box of claim 2, wherein the front attachment system comprising magnets.

7. The speaker installation box of claim 2, wherein the front attachment system comprising hook-and-loop fasteners.

8. The speaker installation box of claim 1, wherein the power connector supporting a low voltage power supply.

9. The speaker installation box of claim 1, wherein the power connector supporting DC current.

10. The speaker installation box of claim 1, wherein the power connector supporting AC current.

11. The speaker installation box of claim 1, further comprising:
a speaker mounting panel.

12. The speaker installation box of claim 11, further comprising:
a speaker control set on the speaker mounting panel.

13. The speaker installation box of claim 12, wherein the speaker control set including operational functionality of one or more of power on, power off, change source, and reset.

14. A speaker installation box, for placement recessed within a wall, comprising:
a housing having a housing interior, a housing exterior and a wall securement system;
the wall securement system capable of securing the housing recessed within a wall;
the housing interior sized to receive a wireless speaker circuit board and a speaker set;
a power connector positionable in the housing interior;
a power access orifice in the housing supporting the routing of power cord between the housing exterior and the housing interior; and
a speaker control set including operational functionality of one or more of power on, power off, change source, and reset.

15. The speaker installation box of claim 14, wherein the power connector supporting a low voltage power supply.

16. The speaker installation box of claim 14, wherein the power connector supporting DC current.

17. The speaker installation box of claim 14, wherein the power connector supporting AC current.

18. A speaker installation box, for placement recessed within a wall, comprising:
a housing having a housing interior, a housing exterior and a wall securement system;
the wall securement system capable of securing the housing recessed within the wall;
the housing interior sized to receive a self-contained wireless speaker system;
a power connector positionable in the housing interior; and
a power access orifice in the housing supporting the routing of a power cord between the housing exterior and the housing interior.

19. The speaker installation box of claim 18, wherein the power connector supporting DC current.

20. The speaker installation box of claim 18, wherein the power connector supporting AC current.
